(19) United States
(12) Patent Application Publication
(10) Pub. No.: US 2026/0131795 A1
(43) Pub. Date: May 14, 2026

(54) REVEALED OBJECT DETECTION

(71) Applicant: GM GLOBAL TECHNOLOGY OPERATIONS LLC, DETROIT, MI (US)

(72) Inventors: Ashraf Abualfellat, Grand Blanc, MI (US); Mohammadali Shahriari, Markham (CA); Amanpal S. Grewal, Novi, MI (US); Dmitriy Feldman, West Bloomfield, MI (US)

(21) Appl. No.: 18/941,511

(22) Filed: Nov. 8, 2024

(51) Int. Cl. B60W 50/00; B60W 50/14; G06V 10/764; G06V 20/58

(52) U.S. Cl. CPC B60W 50/0097; B60W 50/14; G06V 10/764; G06V 20/58; B60W 30/0956; B60W 60/0015; B60W 60/0027; B60W 2420/403; B60W 2554/4041; B60W 2554/4046; G06V 2201/08

(57) ABSTRACT

A system for monitoring a vehicle environment includes a perception system in communication with a vehicle sensor, the perception system configured to receive perception data from the vehicle sensor. The system also includes a scenario detection module configured to detect a first object based on the perception data, and analyze a behavior of the first object to predict whether a reveal scenario is occurring or is to occur, where an obstructed object is revealed in the reveal scenario. The system further includes a control module configured to, based on detection of the obstructed object as a revealed object, perform at least one of controlling a vehicle to respond to the obstructed object, and presenting information regarding the obstructed object to a user.

### INTRODUCTION

The subject disclosure relates to the art of vehicle perception. More particularly, the subject disclosure relates to systems and methods for monitoring vehicle environments and/or controlling a vehicle perception system based on detection of revealed objects.

Vehicles are increasingly equipped with sensors and perception devices that improve the awareness of vehicle control systems and drivers, and can thereby provide for autonomous control and/or driver support. For example, vehicles may feature autonomous and/or semi-autonomous drive modes, such as fully autonomous control and automated control of specific functions (e.g., parking assist, automated control during highway driving, brake assist, etc.). Perception systems are intended to be able to detect a wide variety of dynamic situations and objects. It is desirable to improve aspects of object detection and reaction to dynamic events.

### SUMMARY

In one exemplary embodiment, a system for monitoring a vehicle environment includes a perception system in communication with a vehicle sensor, the perception system configured to receive perception data from the vehicle sensor. The system also includes a scenario detection module configured to detect a first object based on the perception data, and analyze a behavior of the first object to predict whether a reveal scenario is occurring or is to occur, where an obstructed object is revealed in the reveal scenario. The system further includes a control module configured to, based on detection of the obstructed object as a revealed object, perform at least one of controlling a vehicle to respond to the obstructed object, and presenting information regarding the obstructed object to a user.

In addition to one or more of the features described herein, the perception system is configured to operate in a normal detection mode and a modified detection mode, object detection is performed based on a normal set of criteria in the normal detection mode, the object detection is performed based on a modified set of criteria in the modified detection mode, and the scenario detection module is configured to cause the perception system to transition from the normal detection mode to the modified detection mode based on predicting that the reveal scenario is occurring or is to occur.

In addition to one or more of the features described herein, the normal detection mode prescribes that the perception system perform the object detection based a first number of detection modalities, and the modified detection mode prescribes that the perception system perform the object detection based on a reduced number of detection modalities, the reduced number being less than the first number.

In addition to one or more of the features described herein, the normal detection mode is associated with a first delay, and the modified detection mode is associated with a second delay, the second delay being less than the first delay.

In addition to one or more of the features described herein, the scenario detection module is configured to predict that the reveal scenario is occurring or is to occur based on a maneuver performed by the first object.

In addition to one or more of the features described herein, the first object is a leading vehicle traveling ahead of the vehicle, the obstructed object is a third vehicle ahead of the leading vehicle, and the maneuver is an aggressive maneuver performed by the first object.

In addition to one or more of the features described herein, the scenario detection module is configured to predict that the reveal scenario is occurring or is to occur based on classifying the behavior according to a machine learning model.

In addition to one or more of the features described herein, the first object is a leading vehicle traveling ahead of the vehicle, and the machine learning model is configured to determine whether the behavior is classified as an aggressive maneuver.

In addition to one or more of the features described herein, the perception system is configured to perform object detection according to a normal detection mode and a modified detection mode, the normal detection mode is associated with a first delay, the modified detection mode is associated with a second delay that is less than the first delay, and the scenario detection module is configured to cause the perception system to operate in the modified detection mode based on determining that the behavior is classified as the aggressive maneuver.

In another exemplary embodiment, a method of monitoring a vehicle environment includes receiving perception data from a vehicle sensor of a perception system of a vehicle, detecting a first object in an environment around the vehicle based on the perception data, and analyzing a behavior of the first object to predict whether a reveal scenario is occurring or is to occur, where an obstructed object is revealed in the reveal scenario. The method also includes, based on predicting that the reveal scenario is occurring or is to occur, and based on detection of the obstructed object as a revealed object, performing at least one of controlling the vehicle to respond to the obstructed object, and presenting information regarding the obstructed object to a user.

In addition to one or more of the features described herein, the perception system is configured to operate in a normal detection mode and a modified detection mode, object detection is performed based on a normal set of criteria in the normal detection mode, and the object detection is performed based on a modified set of criteria in the modified detection mode.

In addition to one or more of the features described herein, the method includes causing the perception system to transition from the normal detection mode to the modified detection mode based on predicting that the reveal scenario is occurring or is to occur.

In addition to one or more of the features described herein, the normal detection mode prescribes that the perception system perform the object detection based a first number of detection modalities, and the modified detection mode prescribes that the perception system perform the object detection based on a reduced number of detection modalities, the reduced number being less than the first number.

In addition to one or more of the features described herein, predicting whether the reveal scenario is occurring or is to occur is based on a maneuver performed by the first object.

In addition to one or more of the features described herein, predicting whether the reveal scenario is occurring or is to occur is based on classifying the behavior according to a machine learning model.

In addition to one or more of the features described herein, the first object is a leading vehicle traveling ahead of the vehicle, and the machine learning model is configured to determine whether the behavior is classified as an aggressive maneuver.

In yet another exemplary embodiment, a vehicle system includes a perception system in communication with a vehicle sensor, the perception system configured to receive perception data from the vehicle sensor and perform object detection. The perception system is configured to operate in a normal detection mode and a modified detection mode, the object detection is performed based on a normal set of criteria in the normal detection mode, and the object detection is performed based on a modified set of criteria in the modified detection mode. The vehicle system also includes a scenario detection module configured to detect a first object based on the perception data, and analyze a behavior of the first object to predict whether a reveal scenario is occurring or is to occur, where an obstructed object is revealed in the reveal scenario. The scenario detection module is configured to cause the perception system to transition from the normal detection mode to the modified detection mode based on predicting that the reveal scenario is occurring or is to occur.

In addition to one or more of the features described herein, the normal detection mode prescribes that the perception system perform the object detection based a first number of detection modalities, and the modified detection mode prescribes that the perception system perform the object detection based on a reduced number of detection modalities, the reduced number being less than the first number.

In addition to one or more of the features described herein, the scenario detection module is configured to predict whether the reveal scenario is occurring or is to occur based on a maneuver performed by the first object.

In addition to one or more of the features described herein, the scenario detection module is configured to predict whether the reveal scenario is occurring or is to occur based on classifying the behavior according to a machine learning model.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic top view of a motor vehicle, in accordance with an exemplary embodiment;

FIG. 2 depicts an example of a situation for which a reveal scenario may arise;

FIG. 3 depicts an example of a reveal scenario in which a target object makes an aggressive maneuver that results in another object being revealed;

FIG. 4 is a flow diagram depicting aspects of a revealed object detection method, in accordance with an exemplary embodiment; and

FIG. 5 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems are provided for monitoring and detection or prediction of revealed objects. A “revealed object” is an object that is revealed (i.e., is observed to be in a projected path of a vehicle) or is predicted to be revealed, such that the vehicle's perception system may not normally be able to detect the object in a timely manner so that the vehicle can react to the object (e.g., avoid the object entirely or at least reduce damage).

An embodiment of a system is configured to monitor an environment of a vehicle during travel, and analyze perception data to predict whether a reveal scenario is to occur. The reveal scenario may be predicted using a machine learning classifier to classify objects, object maneuvers and other features of the environment. In an embodiment, based on predicting a reveal scenario, the system causes the perception system to transition from a normal mode to a modified mode. In the modified mode, the perception system is configured to detect objects based on a modified set of criteria that allows the perception system to positively identify objects in a shorter time than if the perception system was in the normal mode.

Embodiments described herein present a number of advantages. For example, the embodiments provide for enhancing detection and the ability of a vehicle or driver to address dynamic conditions. In addition, the embodiments provide an improvement of a vehicle's perception system, for example, in situations where uncertainty in perception could lead to a missed detection.

Systems in autonomous and manually controlled vehicles, such as adaptive cruise control (ACC) systems, rely on radars and cameras to detect and track objects, but radar uncertainty can lead to false detections or missed objects. This uncertainty is more pronounced for revealed objects. Accordingly, perception systems can take a longer time to confirm detection of an object. Such a delay could result in the vehicle or driver not having sufficient time to effectively react to a revealed object.

Embodiments described herein address such limitations by providing a robust detection algorithm for revealed objects that leverages a systematic algorithm to mitigate the impact of radar uncertainty by utilizing surrounding objects and features to intelligently infer the presence of objects based on their revealed effects on the surrounding environment, so that revealed objects can be timely detected. Embodiments allow for object detection in reveal scenarios and other challenging scenarios, such as low visibility conditions or when objects are partially obscured.

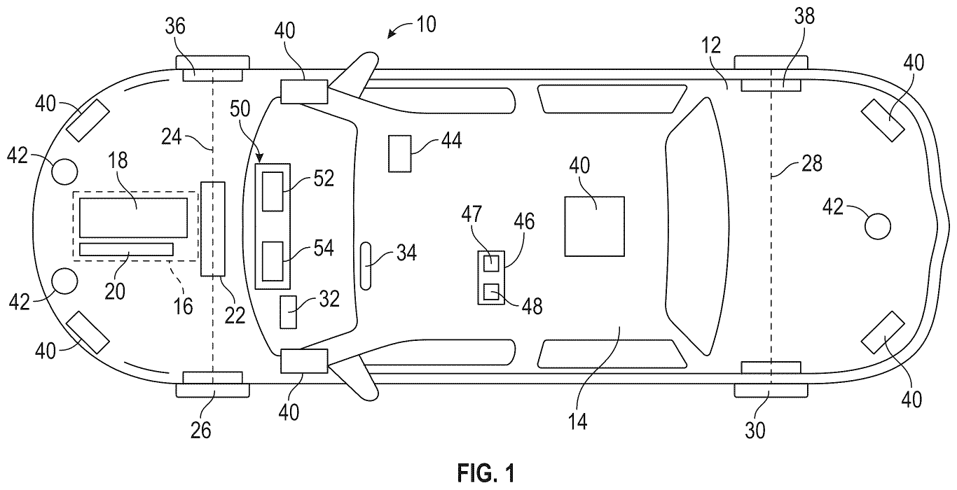

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion systems 16 and other vehicle components, such as a braking subsystem, a suspension system, a steering subsystem, and if the vehicle is a hybrid electric vehicle, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor 20. The vehicle 10 may be a fully electric vehicle having one or more electric motors.

The propulsion system 16 includes various other components, such as a transmission system 22 for applying torque to a front drive shaft 24 connected to front wheels 26. The propulsion system 16 is not so limited. For example, the propulsion system 16 may include components (e.g., transmission, the motor 20 and/or an additional motor) for driving a rear drive shaft 28 connected to rear wheels 30.

The vehicle 10 also includes various control devices for controlling aspects of vehicle operation. Such devices include, for example, an accelerator 32, steering wheel 34, front brakes 36 and rear brakes 38.

The vehicle also includes a perception system and a vehicle control system, aspects of which may be incorporated in or connected to the vehicle 10. The perception system receives perception data (e.g., images) from various sensors, which may represent various types of detection modalities. In an embodiment, the sensors include one or more optical cameras 40 configured to take images, which may be still images and/or video images. Additional devices or sensors may be included, such as one or more radar assemblies 42 included in the vehicle 10. The perception system is not so limited and may include other types of sensors, such as lidar, infrared cameras, microphones, and others.

Control devices and actuators, and other components such as the monitoring system, are controllable via one or more control units, collectively represented by a vehicle controller 44. The vehicle controller 44 includes processing components for controlling aspects of vehicle operation, such as control of propulsion, braking and steering, as well as functions such as monitoring and path planning.

The vehicle controller 44 may be configured to control the vehicle 10 in accordance with various forms of automated control. In an embodiment, the vehicle controller 44 is configured for one or more automation levels, such as Level 1, Level 2 and/or Level 3 automation. Level 1 automation includes driver assistance. Level 2 automation allows for vehicle control of steering and acceleration, with the driver monitoring and ready to take control at any time. In Level 3 automation (conditional automation), a vehicle can monitor the environment and automatically control the operation.

In an embodiment, the perception system includes a monitoring unit 46 configured to receive data from perception devices, such as the optical cameras 40 and the radar assemblies 42. The monitoring unit 46 is configured to detect objects and situations in an environment around the vehicle, and provide object detection information to the driver and/or the vehicle controller 44. For example, the monitoring unit 46 can present object detection and vehicle trajectory information to the driver via an on-board computer system 50 and/or infotainment system (e.g., as a graphical and/or textual display).

The monitoring unit 46 includes, or is connected to, a scenario detection module 48 configured to detect or predict scenarios associated with increased uncertainty. Such scenarios may include any condition or feature of the environment that increases uncertainty, such as low visibility scenarios and reveal scenarios. In an embodiment, the scenario detection module 48 is configured to detect or predict a reveal scenario. Reveal scenarios may be predicted using a machine learning model 47 as described further herein.

A “reveal scenario” is a scenario in which an object (which may have been previously obstructed or partially obstructed) appears in a projected path of the vehicle 10, such that the vehicle 10 may need to react to avoid a collision or other un-intended consequence. Also in a reveal scenario, the perception system may not normally (i.e., when in a normal detection mode) be able to positively detect the object (using normal criteria, such as a requirement that multiple modalities be used to detect and confirm the presence of the object) before the vehicle 10 may need to react.

As discussed further herein, the scenario detection module 48 is configured to predict that a reveal scenario is occurring or is imminent, and direct the perception system to transition into a detection mode (referred to as a “modified detection mode”) that is less stringent or robust than the normal mode. In the modified detection mode, the perception system can more quickly analyze perception data and detect any revealed objects, as criteria for detecting an object are relaxed in the modified detection mode, as compared to the normal detection mode.

In this way, a normal delay inherent in the normal detection mode due to a prescribed set of criteria (“normal criteria”) can be reduced to allow for quicker detection. For example, in a normal detection mode, the perception system is required to analyze both optical and radar images (or other group of multiple detection modalities). In the modified detection mode, the perception system may only be required to use one modality or fewer modalities (e.g., optical or radar images), and thus can make a determination as to whether an object is detected in a shorter time.

The vehicle 10, monitoring system, the vehicle controller 44 and other vehicle systems are included in, or are connected to, an on-board computer system 50 that includes one or more processing devices 52 and a user interface 54. The user interface 54 may include a touchscreen, a speech recognition system and/or various buttons for allowing a user to interact with features of the vehicle. The user interface 54 may be configured to interact with a user or driver via visual communications (e.g., text and/or graphical displays), tactile communications or alerts (e.g., vibration), and/or audible communications.

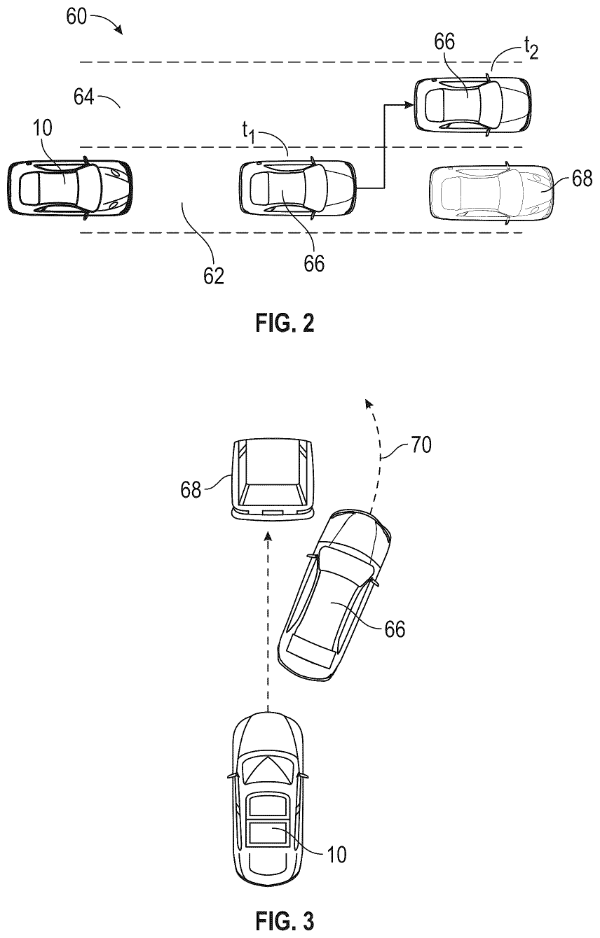

FIG. 2 depicts an example of a situation in which a reveal scenario could arise. At a first time t₁ (a “current time”), the vehicle 10 is traveling along a roadway 60, such as a highway. The roadway includes lanes 62 and 64, and the vehicle 10 is currently traveling in the lane 62. Another vehicle 66 (“leading vehicle”) is traveling in the lane 62 ahead of the vehicle 10. In addition, a third vehicle 68 is traveling in the lane 62 ahead of the leading vehicle 66. At the first time t₁, the third vehicle 68 is at least partially obstructed from view of the vehicle 10.

At a second time t₂, the leading vehicle 66 may choose to maneuver into the lane 64. The maneuver may be a relatively gradual maneuver, which allows the perception system of the vehicle 10 to detect the third vehicle 68 according to a normal detection mode. However, if the maneuver is abrupt or aggressive, the perception system may not be able to detect the third vehicle 68 quickly enough to alert the vehicle 10 and/or the user and permit enough time for the vehicle 10 to properly react and effectively avoid the third vehicle 68.

FIG. 3 depicts an example of a maneuver executed by a detected object, which is associated with a reveal scenario. In this example, the leading vehicle 66 performs an aggressive cut-out maneuver (denoted by arrow 70), in which the leading vehicle 66 makes an abrupt lane change to avoid or pass the obstructed vehicle 68. The scenario detection module 48, in an embodiment, analyzes the dynamic behavior of the leading vehicle, and determines whether the maneuver is classified as an “aggressive maneuver” (e.g., using a classifier or other machine learning model)

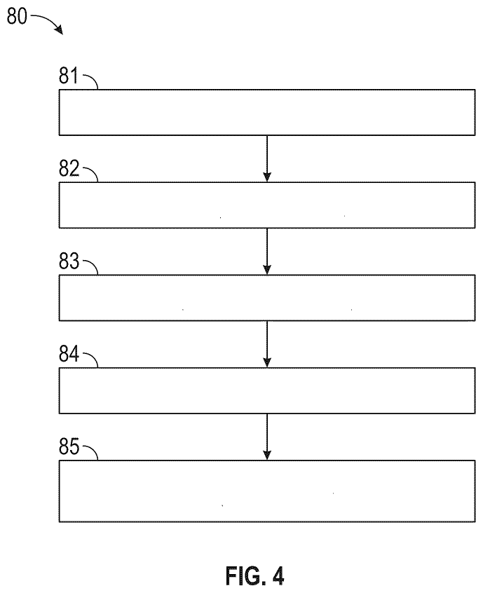

FIG. 4 depicts an embodiment of a method 80 of monitoring a vehicle environment. The method 80 is discussed in conjunction with blocks 81-85. The method 80 is not limited to the number or order of steps therein, as some steps represented by blocks 81-85 may be performed in a different order than that described below, or fewer than all of the steps may be performed.

The method 80 is discussed in conjunction with the vehicle 10 of FIG. 1 and the scenario detection module 48, but is not so limited and may be performed by any suitable processing device or combination of processing devices (e.g., the computer system 50, the monitoring unit 46, or a combination thereof).

Also, the method 80 is discussed with reference to the situation and scenario shown in FIGS. 2 and 3. The method 80 is not so limited and may be used in any situation in which a previously obstructed or undetected object is revealed.

At block 81, during vehicle operation, the perception system monitors the surrounding environment in a normal detection mode and detects one or more objects. The normal detection mode includes an identification method that prescribes functions, such as inputting image data into a machine learning model (e.g., a deep neural network (DNN)), and identifying objects in the environment.

The normal detection mode may require that multiple modalities be used to identify an object. For example, in the normal detection mode, the perception system uses both optical images from one or more cameras 40 and radar images from one or more radar assemblies 42 for object identification. A data fusion method may be performed in combination with other processes (e.g., object classification) to detect an object. For example, the monitoring unit 46 receives optical images and radar images, and detects that the leading vehicle 66 is travelling ahead.

The vehicle 10 may be operated manually, autonomously or semi-autonomously. For example, object detection information may be provided to an autonomous control system, or used for semi-autonomous control, such as adaptive cruise control (ACC). In addition, or alternatively, information regarding the environment is presented to a user (e.g., driver), such as in a touchscreen or heads-up display.

At block 82, the scenario detection module 48 acquires historical data related to the trajectory and behavior of a detected object (i.e., an object detected via the normal detection mode). The historical data is used to predict a trajectory of the detected object. The historical data may be recorded observations of the object (and/or objects of a similar type and/or objects in similar environments). The observations include one or more behaviors associated with a given maneuver or action of the object.

The behavior of the object may be predicted by comparing detected behaviors of the object to historical behaviors. In an embodiment, a machine learning model is used to predict the trajectory of the detected object.

For example, the perception system monitors the leading vehicle 66 and identifies various behaviors, such as changes in speed and direction, and determines which behaviors of the leading vehicle 66 are aggressive maneuvers or other behaviors associated with revealed scenarios. For example, trajectories from previous observations are used for comparison.

At block 83, the scenario detection module 48 determines whether the observed behavior is indicative of a reveal scenario. In a reveal scenario, uncertainties associated with detection modalities can be relatively high, which may result in a corresponding delay. In a normal detection mode, the delay may be due to increased processing time in order to reduce or minimize false positives.

The observed behavior may be compared to stored behaviors in a lookup table (or other data structure) to determine whether the observed behavior is indicative of a reveal scenario. In an embodiment, a machine learning model is used to learn behaviors associated with reveal scenarios, and perception data is input to the model to identify behaviors associated with reveal scenario.

For example, the scenario detection module 48 performs a maneuver assessment, in which perception data is input to a trained machine learning model, such as a classifier. Various criteria may be used to classify a behavior, such as kinematic and dynamic analyses of the leading vehicle 66 and/or any other observations. For example, semantic clues may be used, such as whether brake lights are turned on, observed movements of the leading vehicle driver (e.g., which may be indicative of agitation), roadway features (e.g., solid or dashed center lines), road signs and others.

At block 84, if the detected behavior is classified in a classification associated with a reveal scenario, the scenario detection module 48 determines that a reveal scenario is occurring and that an obstructed object may be revealed.

At block 85, based on the determination, the perception system is adjusted to change one or more criteria for object detection. The adjustment results in the perception system being able to make a positive object identification in a shorter time than if the perception system used normal criteria. Although changing the criteria may reduce the confidence of the detection, the perception system can make for a quicker detection of a revealed object.

Upon entering the modified detection mode, the perception system monitors the environment around the vehicle and performs object detection using the adjusted criteria. If a revealed object (e.g., the third vehicle 68 of FIGS. 2 and 3) is detected, the vehicle 10 may be controlled autonomously or semi-autonomously to react to the revealed object. In addition or alternatively, information regarding the revealed object is presented to a user or driver.

In an embodiment, the scenario detection module 48 causes the monitoring unit 46 to transition the perception system from the normal detection mode to a modified detection mode, in response to predicting a reveal scenario. In the modified detection mode, criteria used for object detection are modified. In the modified detection mode, detection criteria are relaxed, so that the monitoring unit 46 can perform objection detection in a shorter time.

In an embodiment, the normal detection mode prescribes that the perception system perform object detection based a first number of detection modalities. The modified detection mode allows for object detection using a reduced number of detection modalities.

For example, in the normal detection mode, the perception system of FIG. 1 uses both optical images from one or more cameras 40 and radar images from one or more radar assemblies 42 for object identification. A data fusion method may be performed in combination with other processes (e.g., object classification) to detect an object. If the leading vehicle 66 makes a lane change in a normal manner, such that the third vehicle 68 is visible but the vehicle 10 has time to react, the perception system detects the third vehicle according to the normal detection mode.

However, if a reveal scenario has been predicted, the perception system transitions to the modified detection mode, and performs object detection. The third vehicle 68 is detected using only using optical or radar images.

In an embodiment, the perception system is transitioned to the modified detection mode by adjusting (e.g., reducing or setting to zero) one or more weights assigned to one or more modalities. For example, when the perception system is in the modified detection mode, a weight associated with optical image data or radar data is set to zero or reduced. As detection can be performed more quickly (in the modified detection mode, the driver and/or the vehicle 10 is/are able to react more quickly than if the normal detection mode is used.

In addition to adjusting the criteria for object detection, the method 80 may include one or more other actions. For example, information related to the environment, detected objects and/or the reveal scenario is presented to the user. For example, the driver may be notified that the perception system has transitioned to the modified detection mode, that a previously obstructed object was detected, and/or that a reveal scenario is identified. Other information may include trajectory and object information, such as in a graphical display.

The vehicle 10 may be autonomously controlled or controlled to assist the driver. For example, the vehicle controller 44 controls the vehicle 10 to perform an evasive maneuver, or a driver assistance system is activated.

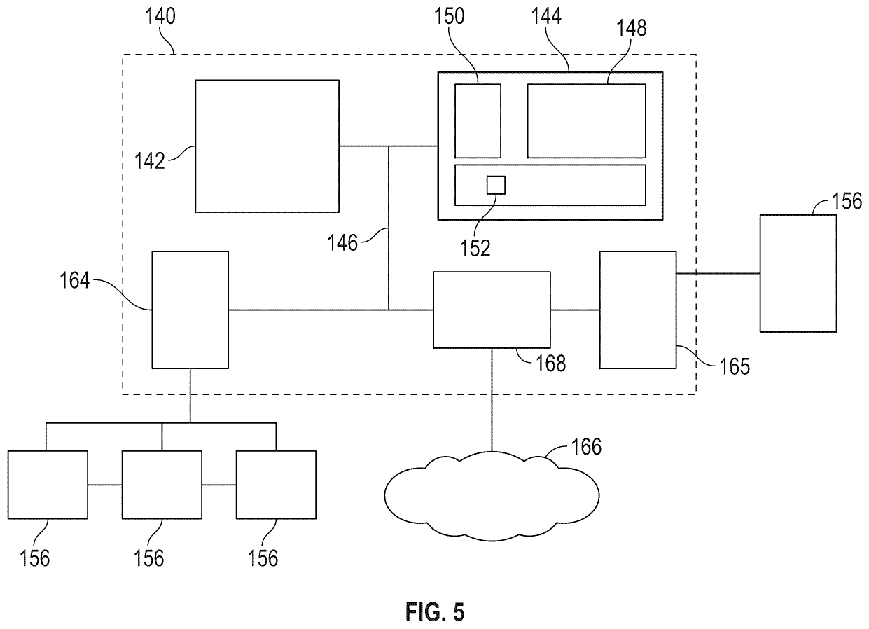

FIG. 5 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for monitoring a vehicle environment, comprising:
a perception system in communication with a vehicle sensor, the perception system configured to receive perception data from the vehicle sensor;
a scenario detection module configured to detect a first object based on the perception data, and analyze a behavior of the first object to predict whether a reveal scenario is occurring or is to occur, wherein an obstructed object is revealed in the reveal scenario; and
a control module configured to, based on detection of the obstructed object as a revealed object, perform at least one of controlling a vehicle to respond to the obstructed object, and presenting information regarding the obstructed object to a user.

2. The system of claim 1, wherein the perception system is configured to operate in a normal detection mode and a modified detection mode, object detection is performed based on a normal set of criteria in the normal detection mode, the object detection is performed based on a modified set of criteria in the modified detection mode, and the scenario detection module is configured to cause the perception system to transition from the normal detection mode to the modified detection mode based on predicting that the reveal scenario is occurring or is to occur.

3. The system of claim 2, wherein the normal detection mode prescribes that the perception system perform the object detection based a first number of detection modalities, and the modified detection mode prescribes that the perception system perform the object detection based on a reduced number of detection modalities, the reduced number being less than the first number.

4. The system of claim 2, wherein the normal detection mode is associated with a first delay, and the modified detection mode is associated with a second delay, the second delay being less than the first delay.

5. The system of claim 1, wherein the scenario detection module is configured to predict that the reveal scenario is occurring or is to occur based on a maneuver performed by the first object.

6. The system of claim 5, wherein the first object is a leading vehicle traveling ahead of the vehicle, the obstructed object is a third vehicle ahead of the leading vehicle, and the maneuver is an aggressive maneuver performed by the first object.

7. The system of claim 1, wherein the scenario detection module is configured to predict that the reveal scenario is occurring or is to occur based on classifying the behavior according to a machine learning model.

8. The system of claim 7, wherein the first object is a leading vehicle traveling ahead of the vehicle, and the machine learning model is configured to determine whether the behavior is classified as an aggressive maneuver.

9. The system of claim 8, wherein the perception system is configured to perform object detection according to a normal detection mode and a modified detection mode, the normal detection mode is associated with a first delay, the modified detection mode is associated with a second delay that is less than the first delay, and the scenario detection module is configured to cause the perception system to operate in the modified detection mode based on determining that the behavior is classified as the aggressive maneuver.

10. A method of monitoring a vehicle environment, comprising:
receiving perception data from a vehicle sensor of a perception system of a vehicle;
detecting a first object in an environment around the vehicle based on the perception data;
analyzing a behavior of the first object to predict whether a reveal scenario is occurring or is to occur, wherein an obstructed object is revealed in the reveal scenario; and
based on predicting that the reveal scenario is occurring or is to occur, and based on detection of the obstructed object as a revealed object, performing at least one of controlling the vehicle to respond to the obstructed object, and presenting information regarding the obstructed object to a user.

11. The method of claim 10, wherein the perception system is configured to operate in a normal detection mode and a modified detection mode, object detection is performed based on a normal set of criteria in the normal detection mode, and the object detection is performed based on a modified set of criteria in the modified detection mode.

12. The method of claim 11, further comprising causing the perception system to transition from the normal detection mode to the modified detection mode based on predicting that the reveal scenario is occurring or is to occur.

13. The method of claim 11, wherein the normal detection mode prescribes that the perception system perform the object detection based a first number of detection modalities, and the modified detection mode prescribes that the perception system perform the object detection based on a reduced number of detection modalities, the reduced number being less than the first number.

14. The method of claim 10, wherein predicting whether the reveal scenario is occurring or is to occur is based on a maneuver performed by the first object.

15. The method of claim 10, wherein predicting whether the reveal scenario is occurring or is to occur is based on classifying the behavior according to a machine learning model.

16. The method of claim 15, wherein the first object is a leading vehicle traveling ahead of the vehicle, and the machine learning model is configured to determine whether the behavior is classified as an aggressive maneuver.

17. A vehicle system comprising:
a perception system in communication with a vehicle sensor, the perception system configured to receive perception data from the vehicle sensor and perform object detection, wherein the perception system is configured to operate in a normal detection mode and a modified detection mode, the object detection is performed based on a normal set of criteria in the normal detection mode, and the object detection is performed based on a modified set of criteria in the modified detection mode; and
a scenario detection module configured to detect a first object based on the perception data, and analyze a behavior of the first object to predict whether a reveal scenario is occurring or is to occur, wherein an obstructed object is revealed in the reveal scenario, and the scenario detection module is configured to cause the perception system to transition from the normal detection mode to the modified detection mode based on predicting that the reveal scenario is occurring or is to occur.

18. The vehicle system of claim 17, wherein the normal detection mode prescribes that the perception system perform the object detection based a first number of detection modalities, and the modified detection mode prescribes that the perception system perform the object detection based on a reduced number of detection modalities, the reduced number being less than the first number.

19. The vehicle system of claim 17, wherein the scenario detection module is configured to predict whether the reveal scenario is occurring or is to occur based on a maneuver performed by the first object.

20. The vehicle system of claim 17, wherein the scenario detection module is configured to predict whether the reveal scenario is occurring or is to occur based on classifying the behavior according to a machine learning model.
